(19) United States
(12) Patent Application Publication
(10) Pub. No.: US 2025/0219838 A1
(43) Pub. Date: Jul. 3, 2025

(54) SECOND FACTOR AUTHENTICATION IN AGENTLESS SOFTWARE AUTOMATION

(71) Applicant: INTERNATIONAL BUSINESS MACHINES CORPORATION, ARMONK, NY (US)

(72) Inventors: Mohamed Zouhaier Ramadhane, Azcapotzalco (MX); Mauro Marzorati, Lutz, FL (US); Jeremy R. Fox, Georgetown, TX (US); Sergio Francisco Inurreta Gonzalez, Cuidad de Mexico (MX); Kasia Karimee Garcia Bracho, Guadalajara (MX)

(21) Appl. No.: 18/401,838

(22) Filed: Jan. 2, 2024

(51) Int. Cl. H04L 9/32; H04L 9/08

(52) U.S. Cl. CPC H04L 9/3228; H04L 9/0863

(57) ABSTRACT

Described are techniques for multi-factor authentication. The techniques include defining a future date and time to implement an automated executable on a server using an agentless Information Technology (IT) automation tool. The techniques further include generating a Future Time-based One-Time Passwords (FTOTP) for the automated executable based on the future date and time. The techniques further include providing the FTOTP to the agentless IT automation tool as a second factor to establish communication with the server for purposes of implementing the automated executable.

### BACKGROUND

The present disclosure relates to cybersecurity, and, more specifically, to multi-factor authentication in agentless software automation tools.

Time-based one-time password (TOTP) is a computer algorithm that generates a one-time password (OTP) that uses the current time as a source of uniqueness. It can be considered an extension of the Hash-based Message Authentication Code (HMAC)-based one-time password algorithm (HOTP). TOTP is used in various two-factor authentication (2FA) systems.

### SUMMARY

In some aspects, the techniques described herein relate to a computer-implemented method including defining a future date and time to implement an automated executable on a server using an agentless Information Technology (IT) automation tool. The computer-implemented method further includes generating a Future Time-based One-Time Passwords (FTOTP) for the automated executable based on the future date and time. The computer-implemented method further includes providing the FTOTP to the agentless IT automation tool as a second factor to establish communication with the server for purposes of implementing the automated executable.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example system for multi-factor authentication in an agentless IT automation tool, in accordance with some embodiments of the present disclosure.

FIG. 2 illustrates a flowchart of an example method for implementing multi-factor authentication in an agentless IT automation tool, in accordance with some embodiments of the present disclosure.

FIG. 3 illustrates a flowchart of an example method for predicting a future execution time using a machine learning model for purposes of generating a Future Time-based One-Time Password (FTOTP), in accordance with some embodiments of the present disclosure.

FIG. 4 illustrates a flowchart of an example method for downloading, executing, metering, and invoicing usage of FTOTP code, in accordance with some embodiments of the present disclosure.

FIG. 5 illustrates a data flow diagram of FTOTP generation, FTOTP authentication, and script execution, in accordance with some embodiments of the present disclosure.

FIG. 6 illustrates a data flow diagram of the operations of, and interactions between, a user device and an agentless IT automation tool, in accordance with some embodiments of the present disclosure.

FIG. 7 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward cybersecurity, and, more specifically, to multi-factor authentication in agentless software automation tools. While not limited to such applications, embodiments of the present disclosure may be better understood in light of the aforementioned context.

The following example clauses illustrate a non-limiting listing of aspects of the present disclosure.

Clause 1. A computer-implemented method comprising defining a future date and time to implement an automated executable on a server using an agentless Information Technology (IT) automation tool. The method further includes generating a Future Time-based One-Time Passwords (FTOTP) for the automated executable based on the future date and time. The method further includes providing the FTOTP to the agentless IT automation tool as a second factor to establish communication with the server for purposes of implementing the automated executable. Advantageously, this aspect of the present disclosure enables the use of multi-factor authentication with agentless IT automation tools through the use of FTOTPs, thereby increasing the security posture of the agentless IT automation tools.

Clause 2 includes the features of Clause 1. In this example, the FTOTP is further based on a hash of the automated executable. Advantageously, including the hash of the automated executable as a component of the FTOTP enables the executing server to confirm that the automated executable has not been maliciously altered or otherwise tampered with. In this way, including the hash of the automated executable as a component of the FTOTP improves the security posture of the agentless IT automation tool.

Clause 3 includes the features of any one of Clause 1 to clause 2. In this example, defining the future data and time to implement the automated executable further comprises inputting information related to the automated executable, the server, and the agentless IT automation tool to a trained machine learning model, and outputting, from the trained machine learning model, the future date and time. Advantageously, utilizing a machine learning model to predict the future date and time for the FTOTP further automates the multi-factor authentication protocol described in the present disclosure. Additionally, utilizing a machine learning model to predict the future date and time for the FTOTP enables aspects of the present disclosure to be scaled to hundreds, thousands, and millions of automated executables deployed in high-throughput agentless IT automation tools.

Clause 4 includes the features of any of Clause 1 to Clause 3. In this example, the FTOTP is further based on an offset. Advantageously, utilizing an offset in the FTOTP increases the cybersecurity posture of the FTOTP by masking the future date and time.

Clause 5 includes the features of Clause 4. In this example, the offset is a static offset, and the FTOTP is characterized by ƒ(t+o) where t is time, o is the static offset, and f is a function used to determine the FTOTP. Advantageously, a static offset realizes the cybersecurity benefits of an offset in a relatively computationally inexpensive manner.

Clause 6 includes the features of Clause 4. In this example, the offset is a variable offset, and the FTOTP is characterized by ƒ(t)+g(t) where t is time, ƒ is a function used to determine the FTOTP, and g is the function used to determine the variable offset. Advantageously, a variable offset realizes the cybersecurity benefits of an offset in a robust manner that is relatively more resilient to compromise.

Clause 7 includes the features of Clause 4. In this example, the offset is multiple functions, and the FTOTP is characterized by g(ƒ(t)) where t is time, ƒ is a function used to determine the FTOTP, and g is another function. Advantageously, an offset including multiple functions realizes the cybersecurity benefits of an offset in a robust manner that is relatively more resilient to compromise. In particular, wrapping function ƒ by an additional function g enables fine-tuning of computational efficiency and cyber-resiliency to the FTOTP.

Clause 8 includes the features of Clause 4. In this example, the offset is multiple functions, and the FTOTP is characterized by ƒ(g(t)) where t is time, ƒ is a function used to determine the FTOTP, and g is another function. Advantageously, an offset including multiple functions realizes the cybersecurity benefits of an offset in a robust manner that is relatively more resilient to compromise. In particular, inputting to function ƒ an additional function g enables fine-tuning of computational efficiency and cyber-resiliency to the FTOTP.

Clause 9 includes the features of Clause 4. In this example, the offset is an external value obtained from an external data source, and the FTOTP is characterized by ƒ(t+o) where t is time, o is the external value obtained from the external data source, and ƒ is a function used to determine the FTOTP. Advantageously, an offset retrieved from an external data source can introduce a variable totally unrelated to the FTOTP into the FTOTP algorithm, thereby increasing the cyber-resiliency of the resulting FTOTP.

Clause 10 includes the features of any of Clause 1 to Clause 9. In this example, the method is implemented by FTOTP code downloaded from a remote data processing system, and the computer-implemented method further comprises metering usage of the FTOTP code, and generating an invoice based on metering the usage of the FTOTP code. Advantageously, the above example enables aspects of the present disclosure to be delivered as a service to an existing agentless IT automation tool, thereby enabling ad-hoc and on-the-fly provisioning of aspects of the present disclosure to pre-existing agentless IT automation tool infrastructure.

Clause 11. A system comprising: one or more processors; and one or more computer-readable storage media storing program instructions which, when executed by the one or more processors, are configured to cause the one or more processors to perform a method according to any one of Clause 1 to Clause 10. The aforementioned example can thus realize the corresponding advantages discussed above with respect to Clause 1 to Clause 10.

Clause 12. A computer program product comprising one or more computer readable storage media, and program instructions collectively stored on the one or more computer readable storage media, the program instructions comprising instructions configured to cause one or more processors to perform a method according to any one of Clause 1 to Clause 10. The aforementioned example can thus realize the corresponding advantages discussed above with respect to Clause 1 to Clause 10.

In one example technical use case, the FTOTP is implemented in an agentless IT automation tool (e.g., Red Hat® Ansible®) to enable the agentless IT automation tool to utilize multi-factor authentication, thereby increasing the security posture of the agentless IT automation tool.

Aspects of the present disclosure are directed toward incorporating an arbitrary second factor in time-based one-time passwords (TOTPs) for agentless Information Technology (IT) automation tools. Agentless IT automation tools (e.g., Red Hat® Ansible®) are widely used and gaining popularity due to the increased productivity and ease of use they provide. Although agentless IT automation tools provide significant advantages (e.g., by virtue of being agentless), they need to connect to other Operating Systems (e.g., servers) to execute various tasks. Therefore, credentials (e.g., username, password, etc.) are stored in the agentless IT automation system. Most of those systems encrypt the credential, but they can only encrypt them with symmetric algorithms in order to be able to decrypt them during execution. This creates a security issue since most of the credentials used in automation involve privileged users that have the heightened access authority to execute system critical tasks. In other words, if a malicious actor obtains access to an agentless system, the malicious actor can gain full access to execute malicious code in the servers associated with the agentless system (e.g., including changing credentials and/or creating new credentials). Aspects of the present disclosure are directed to solving the above security vulnerability in agentless systems by utilizing a TOTP compatible with agentless systems.

Traditionally, agentless IT automation tools (like Red Hat® Ansible®) have not been compatible with TOTP. The only existing solution to implement TOTP in an agentless IT automation tool involves either disabling the second factor for a functional ID used by the agentless IT automation tool or including the seed in the agentless IT automation tool. Both of those options represent security risks by either lowering the security level or allowing the execution of uncontrolled code. As a result, prior to the present disclosure, software developers created a functional authentication method that did not require TOTP for agentless IT automation tools. In doing so, the cybersecurity posture of the agentless IT automation tool is rendered relatively more vulnerable.

A time-based one-time password (TOTP) is a temporary passcode generated by an algorithm that uses the current time of day as one of its authentication factors. TOTPs can be used for two-factor authentication and have increasingly been adopted by cloud application providers, among other technical implementations. TOTP involves computing the value of a mathematical function for a given input, where the agreed-upon input value is the current time code (e.g., number of seconds since an Epoch), and the factors for the functions are agreed-upon in secret at the onset. Security is assumed insofar as subsequent independent calculations of the function at the current time by two parties resulting in matching values indicate that both parties are in possession of the pre-shared secret.

Aspects of the present disclosure increase the complexity (and, therefore, the security) of the pre-shared secret scheme such that a second external factor is required during automation to complete the operations. For example, aspects of the present disclosure increase the security of the agentless IT automation tool by calculating a Future TOTP (FTOTP) based on a time of a planned execution of an executable script (e.g., an automated executable). Further embodiments of the present disclosure utilize a cryptographic method that ensures a tamper proof script based on the planned execution time (e.g., if a malicious actor changes the executable script, the FTOTP will be different and the associated script will not be executed).

In the traditional TOTP usage model, there is an agreement that the calculation is done for the current time and the only pre-shared secret are the factors of the decay function used in the calculation. Aspects of the present disclosure utilize a second factor associated with a time window when the calculation is made. More specifically, aspects of the present disclosure utilize a time offset. A time offset can be used to enable the programing of the agentless IT automation tool without the need of sharing the TOTP seed, where the future time is defined, and the FTOTP can be related to the execution playbook (e.g., executable automation, executable script, code, etc.). Described below are various ways to introduce the time offset.

In a Static TOTP (SDTOTP) method, the offset is a static value “o”, positive or negative, so that instead of calculating ƒ(x) where x=t, the static TOTP utilizes x=t+o so that the parties know the factors of the decay function ƒ and the static value needed to calculate ƒ(t+o) when time=t.

In a Variable TOTP (VDTOTP) method, the offset “o” is variable according to a variable scheme, such as g(x), such as “add 1” to switch a final TOTP from odd to even. The general form is ƒ(t)+g(t).

In a Chained TOTP (CDTOTP) method, the offset is chained to the result of a prior or post calculation's result, such as for time=t, ƒ(g(t)), or g(ƒ(t)).

In an External TOTP (EDTOTP) method, the offset is a static value looked up from an external data source, such as the current temperature in a given location (e.g., city/state, latitude/longitude coordinates, etc.), or another external value (e.g., a given exchange rate, etc.).

In some additional embodiments of the present disclosure, the valid TOTP is run through a mask, so that only specific TOTP values are valid (e.g., according to a predefined format), such as the TOTP associated with ƒ(t) where t=YYYY/MM/DD.

During implementation, the client and server can be challenged to compute the current token value as per the agreed upon shared secrets and agreed upon method protocol. If the token values are the same, the connection is validated and a server implements an executable automation. If the values are different, the connection is declined or terminated until the FTOTP authentication process is successful.

A high-level summary of some aspects of the present disclosure is now discussed. Aspects of the present disclosure relate to the usage of TOTP with agentless IT automation software. In some embodiments, aspects of the present disclosure calculate a FTOTP based on the planned execution time. In some embodiments, aspects of the present disclosure encode the FTOTP based on a hash of an executable script (e.g., the file including the task to be executed) and the execution time. Doing so protects the executable script from being modified (e.g., tampered with) prior to execution. Advantageously, the aforementioned aspects of the present disclosure do not require the FTOTP to be stored and reverse calculated during execution time. In some embodiments, aspects of the present disclosure can utilize an additional FTOTP used in the computer running the agentless IT automation software. In some embodiments, aspects of the present disclosure utilize a trained Artificial Intelligence (AI) or Machine Learning (ML) model to predict execution time and calculate a potential FTOTP based on the prediction.

Aspects of the present disclosure can be incorporated into Red Hat® Ansible® and/or other agentless IT automation tools (e.g., IBM® Cloud Pak® for Business Automation). The incorporation of aspects of the present disclosure into any of the aforementioned tools improves the cybersecurity of the modified tools by enabling TOTP multi-factor authentication mechanisms in tools previously incompatible with TOTP.

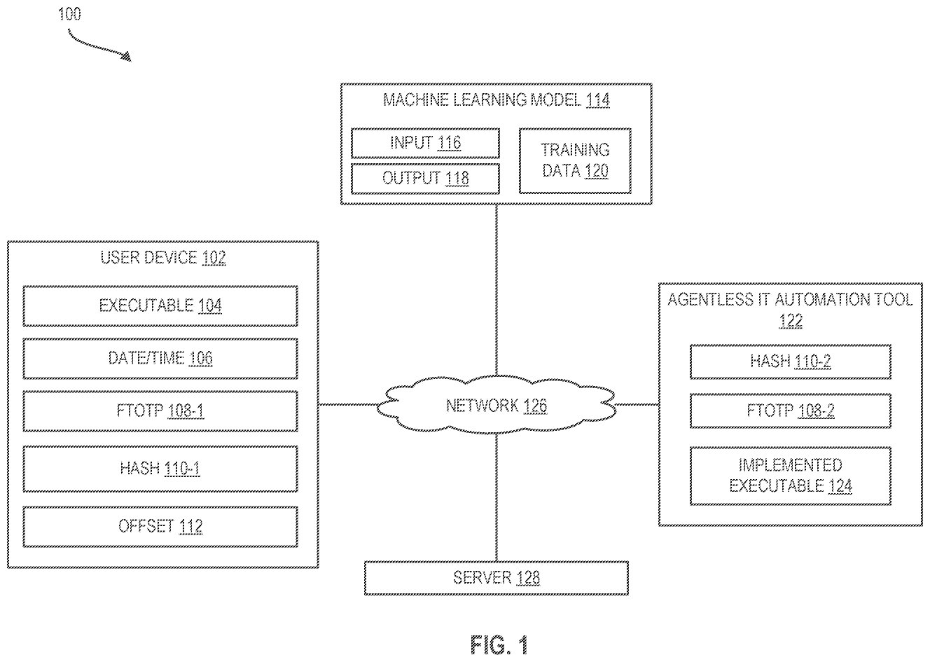

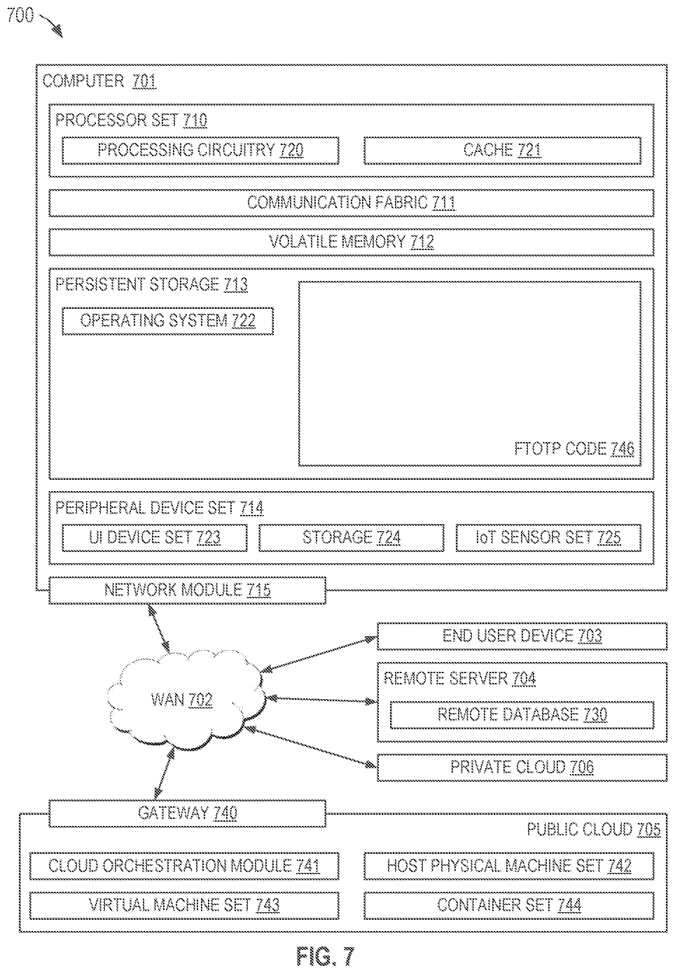

Referring now to the figures, FIG. 1 illustrates a block diagram of an example system 100 for multi-factor authentication in an agentless IT automation tool 122, in accordance with some embodiments of the present disclosure. The system 100 includes a user device 102 communicatively coupled to an agentless IT automation tool 122 via a network 126. In some embodiments, the user device 102 is further communicatively coupled to machine learning model 114 by the same or different network 126. Further, the agentless IT automation tool 122 is communicatively coupled to server 128 by a same or different network 126. The user device 102, machine learning model 114, server 128, and agentless IT automation tool 122 can each comprise hardware and/or software resources (whether physically present or virtually provisioned) to enable the storage, processing, and/or transmission of data between electronic devices. The user device 102, machine learning model 114, server 128, and agentless IT automation tool 122 can thus include processors, computer-readable storage media, computers, and/or other hardware components. For example, the user device 102, machine learning model 114, server 128, and agentless IT automation tool 122 can include one or more of the components described hereinafter with respect to FIG. 7 (e.g., computer 701).

The network 126 can be a local area network (LAN), a wide area network (WAN), an intranet, the Internet, or any other network 126 or group of networks 126 capable of continuously, semi-continuously, or intermittently connecting (directly or indirectly) the aforementioned components. In some embodiments, network 126 is consistent with WAN 702 of FIG. 7.

The user device 102 can include an executable 104. The executable 104 can be an executable block of software code (e.g., a script, a module, a functionality, etc.) that is to be implemented using the agentless IT automation tool 122 in connection with server 128. The user device 102 further includes a date/time 106 defining a future time that the executable 104 is configured to be executed by the agentless IT automation tool 122. The user device 102 further includes a FTOTP 108-1 that is a TOTP with the time variable based on the date/time 106 that the executable 104 is configured to be executed by the agentless IT automation tool 122 (e.g., a future time). The FTOTP 108-1 is thereby capable of incorporating multi-factor authentication using TOTPs into the agentless IT automation tool 122. The user device 102 further includes a hash 110-1 of the executable 104. The hash 110-1 can be used to verify that the executable 104 has not been tampered, altered, or otherwise modified prior to executing the executable 104 by the agentless IT automation tool 122. Although hash 110-1 is shown as distinct from FTOTP 108-1, in some embodiments, the hash 110-1 and the FTOTP 108-1 are incorporated together (e.g., during the FTOTP generation algorithm, when encrypted in combination, etc.).

In some embodiments, the date/time 106 is defined by a user, such as cases where a user manually defines a future date/time 106 when the executable 104 will be implemented at the agentless IT automation tool 122. In other embodiments, the date/time 106 is predicted by a machine learning model 114. The machine learning model 114 can be trained using training data 120 comprising historical logs capturing dates/times of implementation of various executables 104 by various agentless IT automation tools 122. In some embodiments, the machine learning model 114 receives input 116 (e.g., executable 104, user device 102 characteristics, agentless IT automation tool 122 characteristics, etc.) and generates output 118 (e.g., date/time 106).

In some embodiments, the date/time 106 is modified by an offset 112 to increase the cyber-resiliency of the resulting FTOTP 108-1. The offset 112 can be, for example, a static offset, a variable offset, a chained offset, and external offset, or another type of offset.

The agentless IT automation tool 122 can be any agentless IT automation tool now known or later developed. The agentless IT automation tool 122 can generate hash 110-2 of the executable 104 and compare the hash 110-2 to the hash 110-1 to confirm that they match. If they match, executable 104 prepared by the user device 102 for execution using the agentless IT automation tool 122 is, in fact, the same executable 104. If the hash 110-2 does not match the hash 110-1, then the executable 104 prepared by the user device 102 for execution using the agentless IT automation tool 122 is altered, tampered, or otherwise modified and the agentless IT automation tool 122 pauses or cancels implementation of the executable 104.

The agentless IT automation tool 122 further includes FTOTP 108-2 which can be generated by the agentless IT automation tool 122 at the time the executable 104 arrives for implementation using the agentless IT automation tool 122 (e.g., the date/time 106). The agentless IT automation tool 122 can compare the FTOTP 108-2 to the FTOTP 108-1 to confirm that they match. If not, the executable 104 can be paused or canceled. If the FTOTP 108-2 matches the FTOTP 108-1, then the agentless IT automation tool 122 can proceed to serve the executable 104 to the server 128 for implementation and generate implemented executable 124.

The verification of the FTOTP 108-1, FTOTP 108-2 and/or the hash 110-1, hash 110-2 can occur between the user device 102 and the agentless IT automation tool 122 and/or between the agentless IT automation tool 122 and the server 128 selected for running the executable 104.

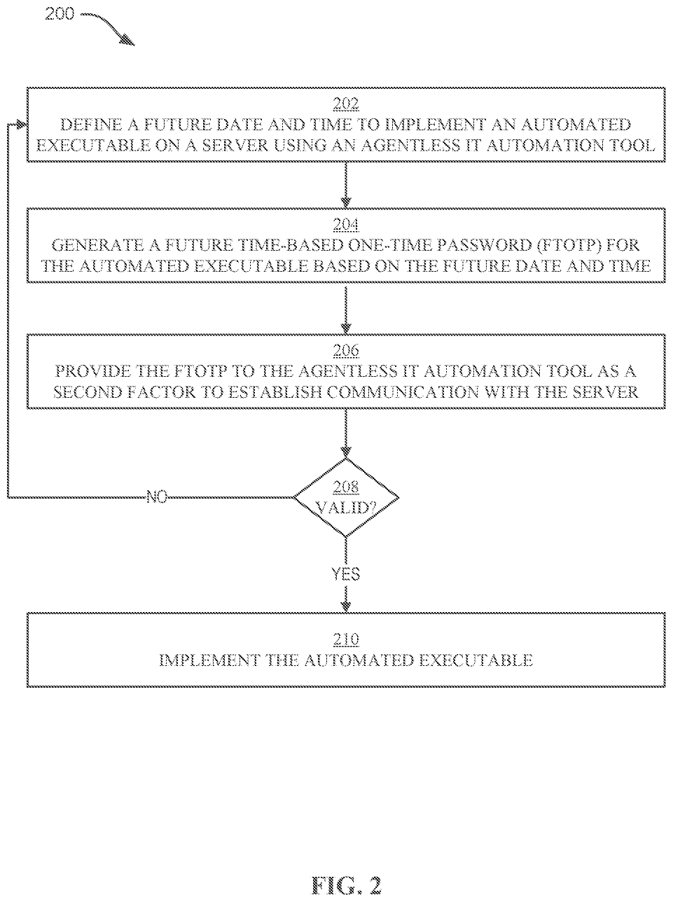

FIG. 2 illustrates a flowchart of an example method 200 for implementing multi-factor authentication in an agentless IT automation tool, in accordance with some embodiments of the present disclosure. The method 200 can be implemented by a computer, a processor, one or more components of FIG. 1, and/or another configuration of hardware and/or software.

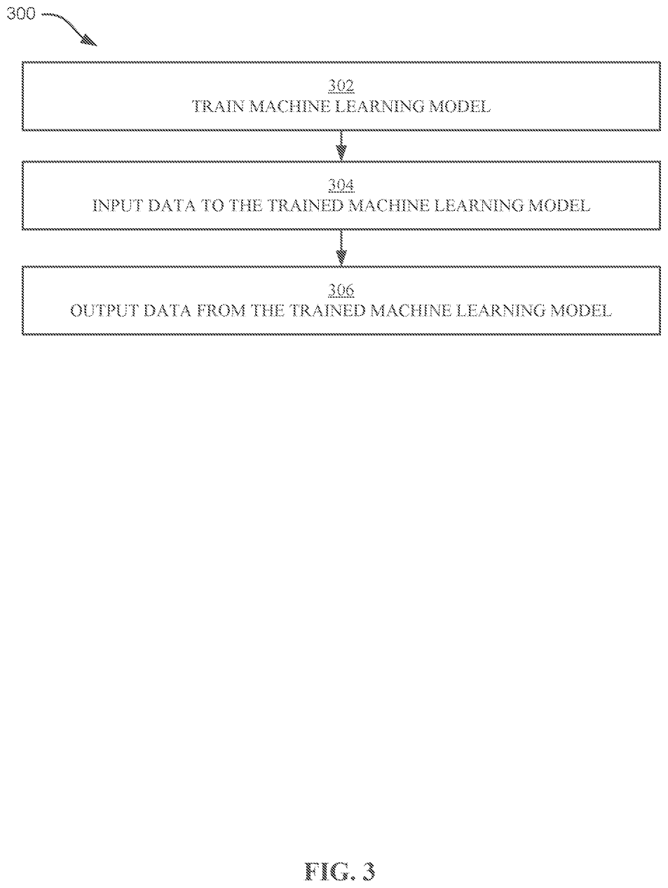

Operation 202 includes defining a future date and time to implement an automated executable on a server using an agentless IT automation tool. The future data and time can be manually defined by a user or predicted using a machine learning model (discussed in more detail hereinafter with respect to FIG. 3).

Operation 204 includes generating a Future Time-based One-Time Password (FTOTP) for the automated executable based on the future date and time. The FTOTP can utilize the future date and time defined in operation 202 in place of the current date and time traditionally utilized by TOTP technology. In some embodiments, the FTOTP further includes an offset to increase the cyber-resiliency of the FTOTP. The offset can be a static offset, variable offset, chained offset, or externally sourced offset as previously described. In some embodiments, the FTOTP is further associated with a hash of the automated executable (whether that hash is used to generate the FTOTP, encrypted together with the FTOTP, or otherwise associated with the FTOTP).

Operation 206 includes providing the FTOTP to the agentless IT automation tool as a second factor to establish communication with the server for purposes of implementing the automated executable. In some embodiments, the FTOTP is provided together with a hash of the automated executable. The hash of the automated executable can be incorporated into the FTOTP or a standalone hash. The hash of the automated executable can enable verification of whether or not the automated executable has been altered, tampered, or otherwise modified relative to the version originally intended for execution.

Operation 208 includes determining if the provided FTOTP is valid. Operation 208 can include comparing the FTOTP provided to the server with another FTOTP generated at the server. The FTOTP generated at the server can utilize the current date and time (which is the future date and time defined in operation 202) to generate the FTOTP. The FTOTP generated at the server can also utilize any offset and/or other pre-shared secret to generate the FTOTP consistent with the provided FTOTP. In some embodiments, operation 208 further determines if the hash of the automated executable received at the agentless IT automation tool matches a hash of the automated executable generated by the agentless IT automation tool.

If the provided FTOTP and the generated FTOTP do not match (208: NO), then the method 200 returns to operation 202 and the automated executable is not implemented. If the provided FTOTP and the generated FTOTP do match (208: YES), then the method 200 proceeds to operation 210.

Operation 210 includes implementing the automated executable using the agentless IT automation tool and the associated server. Advantageously, implementing the automated executable using the agentless IT automation tool improves the security posture of the agentless IT automation tool by incorporating TOTP multi-factor authentication protocols into the agentless IT automation tool.

FIG. 3 illustrates a flowchart of an example method 300 for predicting a future execution time using a machine learning model for purposes of generating a Future Time-based One-Time Password (FTOTP), in accordance with some embodiments of the present disclosure. The method 300 can be implemented by a computer, a processor, one or more components of FIG. 1, and/or another configuration of hardware and/or software. In some embodiments, the method 300 is a sub-method of operation 202 of FIG. 2.

Operation 302 includes training a machine learning model. The machine learning model can be trained using training data comprising historical logs capturing dates/times of implementation of various executables by various agentless IT automation tools. The machine learning model can be trained by performing supervised, unsupervised, or semi-supervised training on the training data, and subsequently applying the generated algorithm or model to generate predicted future dates and times for various automated executables in various agentless IT automation tools.

Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the machine learning algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Operation 304 includes inputting data to the trained machine learning model. Data input to the machine learning model can include data related to the automated executable, a profile associated with the user device defining the automated executable, data related to the agentless IT automation tool, and/or other data.

Operation 306 includes outputting data from the trained machine learning model. The data output from the machine learning model can be one or more predicted future dates and times for implementing the automated executable. In some embodiments, the one or more predicted future dates and times are each associated with a confidence related to the prediction. The one or more predicted future dates and times can be used to generate an FTOTP.

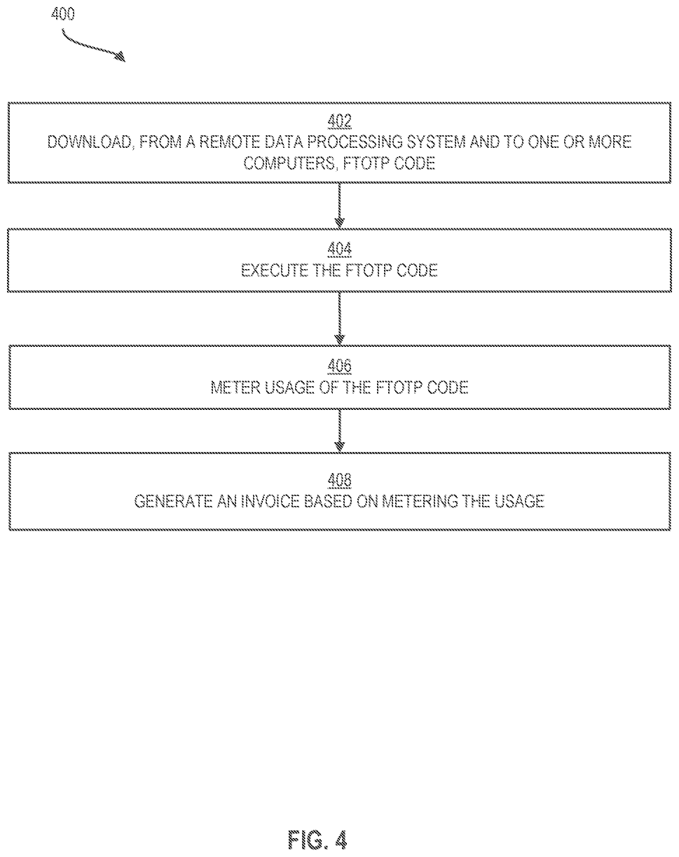

FIG. 4 illustrates a flowchart of an example method 400 for downloading, executing, metering, and invoicing usage of FTOTP code, in accordance with some embodiments of the present disclosure. The method 400 can be implemented by a computer, a processor, one or more components of FIG. 1, and/or another configuration of hardware and/or software. In some embodiments, the method 400 occurs concurrently with any of the methods previously described in FIGS. 2 and 3.

Operation 402 includes downloading, from a remote data processing system and to one or more computers (e.g., user device 102, machine learning model 114, server 128, and/or agentless IT automation tool 122 of FIG. 1, computer 701 of FIG. 7, etc.) FTOTP code (e.g., FTOTP code 746 of FIG. 7). Operation 404 includes executing the FTOTP code. Operation 404 can include performing any of the methods and/or functionalities discussed herein. Operation 406 includes metering usage of the FTOTP code. Usage can be metered by, for example, an amount of time the FTOTP code is used, a number of servers and/or devices deploying the FTOTP code, an amount of resources consumed by implementing the FTOTP code, a number of FTOTPs generated by usage of the FTOTP code, and/or other usage metering metrics. Operation 408 includes generating an invoice based on metering the usage.

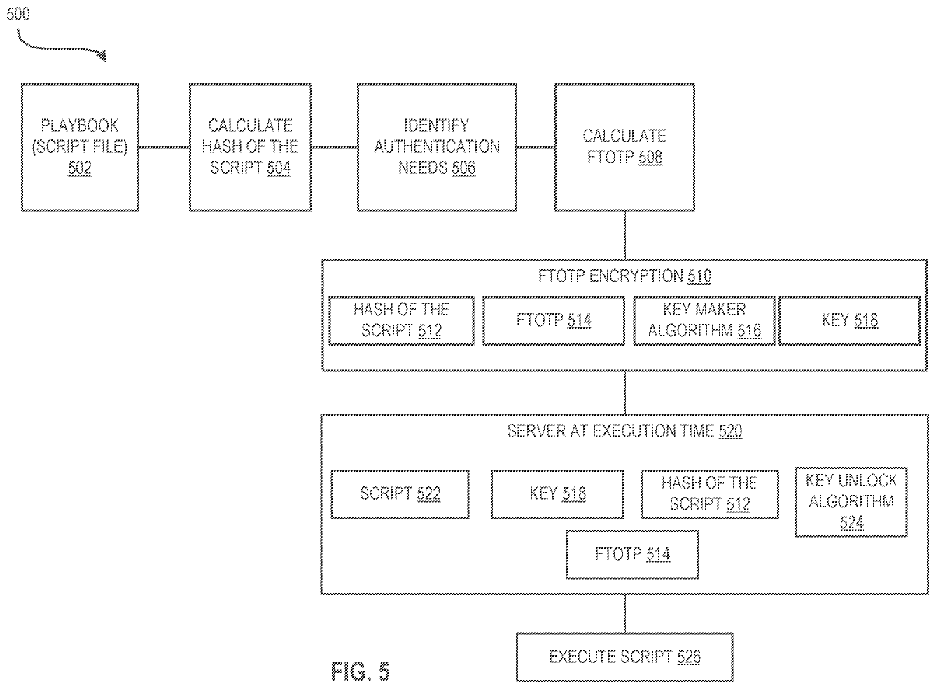

FIG. 5 illustrates a data flow diagram 500 of FTOTP generation, FTOTP authentication, and script execution, in accordance with some embodiments of the present disclosure. The data flow diagram 500 can be implemented using one or more components discussed in FIG. 1 and/or FIG. 7.

The data flow diagram 500 includes defining at 502 a script file (e.g., playbook, automated executable, etc.) and calculating a hash of the script file at 504. The data flow diagram 500 further includes identifying authentication needs (e.g., associated with an agentless IT automation tool and/or script file) at 506. The data flow diagram 500 then calculates an FTOTP at 508 and performs FTOTP encryption at 510. FTOTP encryption at 510 can include inputting a hash of the script 512 and a FTOTP 514 (e.g., future date/time) to a key maker algorithm 516 and outputting, from the key maker algorithm 516, a key 518. The data flow diagram 500 then provides the key 518 to the server at execution time 520. The server at execution time 520 can input the script 522, the key 518, and the hash of the script 512 to a key unlock algorithm 524 to generate the FTOTP 514. If the generated FTOTP 514 is verified, then the data flow diagram 500 proceeds to execute the script at 526.

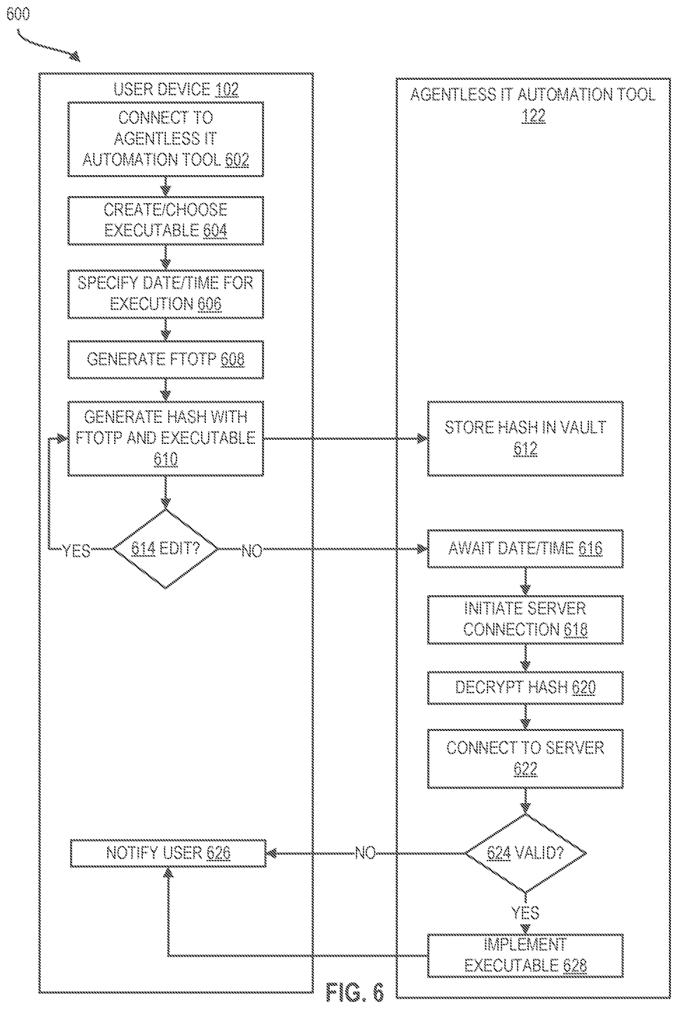

FIG. 6 illustrates a data flow diagram 600 of the operations of, and interactions between, a user device (e.g., user device 102 of FIG. 1) and an agentless IT automation tool (e.g., agentless IT automation tool 122 of FIG. 1), in accordance with some embodiments of the present disclosure. The data flow diagram 600 can be implemented by a computer, a processor, one or more components of FIG. 1, and/or another configuration of hardware and/or software.

In operation 602, the user device 102 connects to the agentless IT automation tool 122. In operation 604, the user device 102 creates or chooses an automated executable. The user device 102 can create the automated executable from scratch or select an automated executable from a preconfigured executable library (e.g., a playbook in Red Hat® Ansible®). In operation 606, the user device 102 can specify a date/time for execution of the automated executable. The specified data/time can be recurrent, and in such embodiments, the user device 102 further defines a start and end time for the recurrence.

In operation 608, the user device 102 generates an FTOTP based on the date/time for execution of the automated executable. The FTOTP can be based on user credentials and/or on system credentials. In operation 610, the user device 102 generates a hash from the FTOTP and the automated executable. In operation 612, the agentless IT automation tool 122 stores the hash in a secure vault (e.g., with symmetric encryption). In operation 614, the user device 102 can modify the automated executable. If so (614: YES), the user device 102 returns to operation 610 to generate a new hash with the FTOTP and the modified automated executable. If not (614: NO), the user device 102 and the agentless IT automation tool 122 await the future date/time in operation 616. In operation 618, the agentless IT automation tool 122 initiates connection with a server for implementing the automated executable. As part of the connection, the server requests user credentials and the second factor (e.g., FTOTP). In operation 620, the agentless IT automation tool 122 decrypts the hash (e.g., decrypts the credential and FTOTP from the secure vault). In other words, at operation 620, the agentless IT automation tool 122 recovers (e.g., decrypts) the credential and the correct FTOTP based on the server, date, time, and automated executable. In operation 622, the agentless IT automation tool 122 attempts to connect to the server using the FTOTP. In operation 624, the agentless IT automation tool 122 receives an indication of whether the connection was valid. If not (624: NO), the agentless IT automation tool 122 notifies the user device 102 of the failed connection at operation 626. If so (624: YES), then the automated executable is implemented at operation 628 and the user device 102 is notified of the successful implementation at operation 626.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 7 illustrates a block diagram of an example computing environment, in accordance with some embodiments of the present disclosure. Computing environment 700 contains an example of an environment for the execution of at least some of the computer code involved in performing the inventive methods, such as FTOTP code 746. In addition to FTOTP code 746, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and FTOTP code 746, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in FTOTP code 746 in persistent storage 713.

COMMUNICATION FABRIC 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface type operating systems that employ a kernel. The code included in FTOTP code 746 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
defining a future date and time to implement an automated executable on a server using an agentless Information Technology (IT) automation tool;
generating a Future Time-based One-Time Passwords (FTOTP) for the automated executable based on the future date and time; and
providing the FTOTP to the agentless IT automation tool as a second factor to establish communication with the server for purposes of implementing the automated executable.

2. The computer-implemented method of claim 1, wherein the FTOTP is further based on a hash of the automated executable.

3. The computer-implemented method of claim 1, wherein defining the future data and time to implement the automated executable further comprises:
inputting information related to the automated executable, the server, and the agentless IT automation tool to a trained machine learning model; and
outputting, from the trained machine learning model, the future date and time.

4. The computer-implemented method of claim 1, wherein the FTOTP is further based on an offset.

5. The computer-implemented method of claim 4, wherein the offset is a static offset, and wherein the FTOTP is characterized by ƒ(t+o) where t is time, o is the static offset, and ƒ is a function used to determine the FTOTP.

6. The computer-implemented method of claim 4, wherein the offset is a variable offset, and wherein the FTOTP is characterized by ƒ(t)+g(t) where t is time, ƒ is a function used to determine the FTOTP, and g is the function used to determine the variable offset.

7. The computer-implemented method of claim 4, wherein the offset is multiple functions, and wherein the FTOTP is characterized by g(ƒ(t)) where t is time, ƒ is a function used to determine the FTOTP, and g is another function.

8. The computer-implemented method of claim 4, wherein the offset is multiple functions, and wherein the FTOTP is characterized by ƒ(g(t)) where t is time, ƒ is a function used to determine the FTOTP, and g is another function.

9. The computer-implemented method of claim 4, wherein the offset is an external value obtained from an external data source, and wherein the FTOTP is characterized by ƒ(t+o) where t is time, o is the external value obtained from the external data source, and ƒ is a function used to determine the FTOTP.

10. The computer-implemented method of claim 1, wherein the method is implemented by FTOTP code downloaded from a remote data processing system, and wherein the computer-implemented method further comprises:
metering usage of the FTOTP code; and
generating an invoice based on metering the usage of the FTOTP code.

11. A system comprising:
one or more processors; and
one or more computer-readable storage media storing program instructions which, when executed by the one or more processors, are configured to cause the one or more processors to perform a method comprising:
defining a future date and time to implement an automated executable on a server using an agentless Information Technology (IT) automation tool;
generating a Future Time-based One-Time Passwords (FTOTP) for the automated executable based on the future date and time; and
providing the FTOTP to the agentless IT automation tool as a second factor to establish communication with the server for purposes of implementing the automated executable.

12. The system of claim 11, wherein the FTOTP is further based on a hash of the automated executable.

13. The system of claim 11, wherein the program instructions configured for defining the future data and time to implement the automated executable comprise additional program instructions configured to perform the method further comprising:
inputting information related to the automated executable, the server, and the agentless IT automation tool to a trained machine learning model; and
outputting, from the trained machine learning model, the future date and time.

14. The system of claim 11, wherein the FTOTP is further based on an offset.

15. The system of claim 14, wherein the offset is a static offset, and wherein the FTOTP is characterized by ƒ(t+o) where t is time, o is the static offset, and ƒ is a function used to determine the FTOTP.

16. The system of claim 14, wherein the offset is a variable offset, and wherein the FTOTP is characterized by ƒ(t)+g(t) where t is time, ƒ is a function used to determine the FTOTP, and g is the function used to determine the variable offset.

17. The system of claim 14, wherein the offset is multiple functions, and wherein the FTOTP is characterized by g(ƒ(t)) where t is time, ƒ is a function used to determine the FTOTP, and g is another function.

18. The system of claim 14, wherein the offset is multiple functions, and wherein the FTOTP is characterized by ƒ(g(t)) where t is time, ƒ is a function used to determine the FTOTP, and g is another function.

19. The system of claim 14, wherein the offset is an external value obtained from an external data source, and wherein the FTOTP is characterized by ƒ(t+o) where t is time, o is the external value obtained from the external data source, and ƒ is a function used to determine the FTOTP.

20. A computer program product comprising one or more computer readable storage media, and program instructions collectively stored on the one or more computer readable storage media, the program instructions comprising instructions configured to cause one or more processors to perform a method comprising:
defining a future date and time to implement an automated executable on a server using an agentless Information Technology (IT) automation tool;
generating a Future Time-based One-Time Passwords (FTOTP) for the automated executable based on the future date and time; and
providing the FTOTP to the agentless IT automation tool as a second factor to establish communication with the server for purposes of implementing the automated executable.
